(19) United States
(12) Patent Application Publication
(10) Pub. No.: US 2026/0050781 A1
(43) Pub. Date: Feb. 19, 2026

(54) SYSTEMS AND METHODS FOR PROVIDING IN-DRAM ACCELERATOR FOR TRANSFORMER NEURAL NETWORKS

(71) Applicants: University of Kentucky Research Foundation, Lexington, KY (US); Colorado State University Research Foundation, Fort Collins, CO (US)

(72) Inventors: Ishan Thakkar, Lexington, KY (US); Sudeep Pasricha, Fort Collins, CO (US); Salma Afifi, Fort Collins, CO (US)

(21) Appl. No.: 19/303,115

(22) Filed: Aug. 18, 2025

Related U.S. Application Data
(60) Provisional application No. 63/684,042, filed on Aug. 16, 2024.

(51) Int. Cl. G06N 3/065; G06N 3/0455

(52) U.S. Cl. CPC G06N 3/065; G06N 3/0455

(57) ABSTRACT

The present disclosure provides a processing-in-memory (PIM) system and method for accelerating transformer neural networks. The system comprises a plurality of subarrays, each subarray of the plurality of subarrays including a plurality of DRAM tiles. The subarrays are equipped with bitlines for performing stochastic multiplication operations, metal-oxide-metal capacitors (MOMCAPs) for accumulating analog values, and stochastic-to-analog (S_to_A) circuits for converting stochastic data into analog charge. The system employs a token-based dataflow scheme to efficiently compute attention scores in transformer layers.

### CROSS REFERENCE

This application claim the benefit of U.S. Provisional Application Ser. No. 63/684,042 which was filed on Aug. 16, 2024, which is hereby incorporated by reference in its entirety.

### BACKGROUND

Deep neural networks (DNNs) have achieved success in various domains, including computer vision, natural language processing, and speech recognition. However, the increasing complexity and size of DNNs pose significant challenges in terms of computational resources and energy efficiency. Transformer neural networks have gained popularity due to their ability to model long-range dependencies and achieve state-of-the-art performance in tasks such as machine translation and language understanding. Nevertheless, the high computational cost associated with self-attention mechanisms in transformer networks has hindered their widespread deployment in resource-constrained environments.

To address these challenges, processing-in-memory (PIM) architectures have emerged as a promising solution. PIM architectures aim to alleviate the data movement bottleneck by integrating processing units close to or within the memory subsystem. Recent advancements in PIM architectures have demonstrated the potential for efficient acceleration of DNNs. For instance, prior works such as Ambit (Seshadri et al., 2017) and FloatPIM (Imani et al., 2019) have proposed in-memory acceleration techniques for bulk bitwise operations and floating-point operations, respectively. However, existing PIM architectures have primarily focused on traditional DNNs, such as convolutional neural networks (CNNs), and have not been optimized for the unique characteristics of transformer networks. Therefore, there is a need for novel PIM architectures and dataflow schemes that can efficiently accelerate transformer neural networks while minimizing data movement and energy consumption.

### SUMMARY

Included are embodiments of a processing-in-memory (PIM) system for accelerating transformer neural networks. Some embodiments include a plurality of subarrays, each subarray of the plurality of subarrays including a plurality of DRAM tiles. Each subarray of the plurality of subarrays may include a plurality of bitlines for performing stochastic multiplication operations, a first metal-oxide-metal capacitor (MOMCAP) for accumulating analog values and a stochastic-to-analog (S_to_A) circuit for converting stochastic data into analog charge for accumulation on the first MOMCAP. In some embodiments, the PIM system is configured to perform multiplication operations on input vectors and weight matrices in the plurality of subarrays, accumulate results of the multiplication operations on the first MOMCAP, and convert the analog accumulated values to binary values.

Also are included embodiments of a PIM system for accelerating transformer neural networks. These embodiments may include a plurality of subarrays, each subarray of the plurality of subarrays including a plurality of DRAM tiles. Each subarray of the plurality of subarrays may include a plurality of bitlines for performing stochastic multiplication operations, a first metal-oxide-metal capacitor (MOMCAP) for accumulating analog values, and a stochastic-to-analog (S_to_A) circuit for converting stochastic data into analog charge for accumulation on the first MOMCAP. The PIM system may be configured to perform multiplication operations on input vectors and weight matrices in the plurality of subarrays, accumulate results of the multiplication operations on the first MOMCAP, convert the analog accumulated values to binary values, and generate final output of a multi-head attention layer.

Some embodiments include a processing-in-memory (PIM) system for accelerating transformer neural networks that includes a plurality of subarrays, each subarray of the plurality of subarrays including a plurality of DRAM tiles. Each subarray of the plurality of subarrays may include a plurality of bitlines for performing stochastic multiplication operations, a metal-oxide-metal capacitor (MOMCAP) for accumulating analog values, and a stochastic-to-analog (S_to_A) circuit for converting stochastic data into analog charge for accumulation on the MOMCAP. In some embodiments, the PIM system is configured to perform a multiplication operation on an input vector and a weight matrix in the plurality of subarrays, accumulate results of the multiplication operations on the MOMCAP, convert the analog accumulated values to binary values, and generate final output of a multi-head attention layer.

### BRIEF DESCRIPTION OF THE DRAWINGS

FIG. 1 depicts a transformer neural network architecture overview, according to embodiments provided herein.

FIG. 2 depicts a component-wise analysis for accelerating transformer neural network computations on traditional PIM architectures, according to embodiments provided herein.

FIGS. 3A, 3B, 3C, 3D depict an ARTEMIS architecture overview showing (a) design of a single bank composed of 128 subarrays, each with 32 tiles, (b) schematic layout of MOMCAP using metal layers (M4-M7), (c) structure of the first NSC unit, (d) structure of the first tile, according to embodiments provided herein.

FIG. 4 depicts MOMCAPs charging during analog accumulation, according to embodiments provided herein.

FIGS. 5A, 5B depict ARTEMIS dataflow scheme examples showing: (a) per-subarray vector multiplication flow with 2 subarrays and 2 tiles, (b) token-based dataflow scheme for computing attention scores in MHA layers with 3 banks, according to embodiments provided herein.

FIG. 6 depicts an ARTEMIS pipelining within one bank for MHA layers, according to embodiments provided herein.

FIG. 7 depicts ARTEMIS experimental results for MOMCAP voltage behavior when storing multiple consecutive accumulations of 128-bit numbers from the DRAM tile bit-lines, according to embodiments provided herein.

FIGS. 8A, 8B depict an example sensitivity analysis showing the impact of token-based dataflow and execution pipelining on (a) speedup, (b) energy, according to embodiments provided herein.

FIG. 9 depicts example speedup comparison between ARTEMIS, CPU, GPU, TPU and PIM accelerators, according to embodiments provided herein.

FIG. 10 depicts an example energy comparison between ARTEMIS, CPU, GPU, TPU and PIM accelerators, according to embodiments provided herein.

FIG. 11 depicts an example power efficiency (COPS W) comparison between ARTEMIS, CPU, GPU, TPU and PIM accelerators, according to embodiments provided herein.

FIG. 12 depicts an ARTEMIS scalability analysis when increasing the input sequence length for transformer neural network models, according to embodiments provided herein.

### DETAILED DESCRIPTION

The present disclosure provides a processing-in-memory (PIM) system and method for accelerating transformer neural networks. In certain aspects, the system comprises a plurality of DRAM tiles, each containing multiple subarrays. The subarrays may be equipped with bitlines for performing stochastic multiplication operations, metal-oxide-metal capacitors (MOMCAPs) for accumulating analog values, and stochastic-to-analog (S_to_A) circuits for converting stochastic data into analog charge. The system may utilize a token-based dataflow approach to efficiently compute attention scores in transformer layers.

In one aspect, a method may involve distributing input matrices across DRAM banks based on a token-sharding mechanism, performing linear layer operations to generate query, key, and value matrices, and computing local attention scores in each bank. The attention scores may be converted between stochastic and binary representations using S_to_B and B_to_S circuits, and transferred between banks using network switching circuits (NSCs). Embodiments further include performing attention score scaling and softmax operations using a log-sum-exp approach, computing attention output matrices, and aggregating the results to generate the final output of the multi-head attention layer.

The proposed PIM system and method offer several advantages over current solutions. By leveraging the computational capabilities of DRAM subarrays and employing a token-based dataflow scheme, the system can efficiently accelerate transformer neural networks while minimizing data movement and energy consumption. The use of stochastic computing techniques and analog accumulation enables high-precision computation with reduced hardware complexity. Overall, the present disclosure provides an efficient approach for accelerating transformer networks using PIM architectures.

Additionally, some embodiments may be configured such that the PIM system accelerates deep neural networks while not requiring external high-bandwidth memory to receive data. In current PIM systems, except DRAM-based PIM systems, external high-bandwidth DRAM memory is required to feed data to the PIM system at high speed. But our PIM system can leverage the internal massive bit-level parallelism, bandwidth, and high storage capacity to eliminate the need for external memory. Similarly, embodiments of the PIM system accelerate deep neural networks with flexible support for various patterns and frequencies of data access and reuse without necessitating data to be presented in a specific access or reuse pattern.

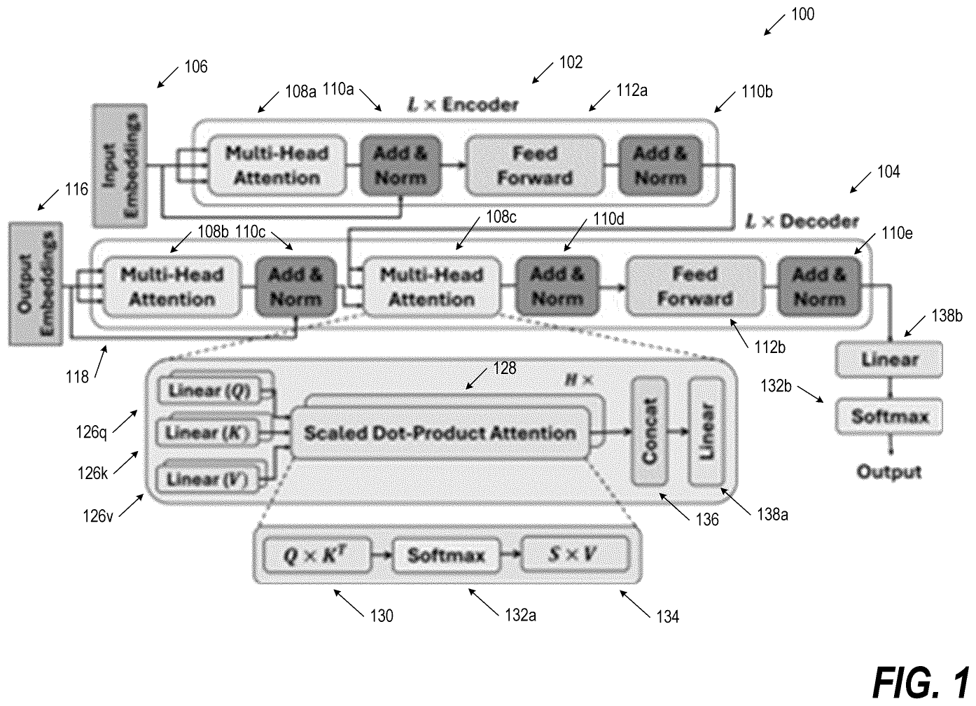

Referring now to the drawings, FIG. 1 depicts a transformer neural network architecture 100, according to embodiments provided herein. Embodiments provided herein include an in-DRAM accelerator that leverages mixed analog-stochastic computations for accelerating transformer neural networks. Due to the distinctive architecture of transformers and their intensive operations which involve a substantial number of MAC computations, embodiments provided herein employ stochastic computing for multiplication operations. This allows the accelerator to perform a single multiply operation in around 34 nanoseconds instead of around 1600 nanoseconds with traditional in-DRAM PIM solutions. Accumulations are performed using a temporal analog accumulation approach which significantly reduces data movement overheads and enables fast and accurate successive data accumulations. To further address the intra-memory data movement bottleneck, an optimized token-based dataflow tailored for the stochastic-analog computational flow, is implemented in the software layer. With a token-based dataflow, memory resources are assigned for computations across different layers based on the input tokens. Accordingly, each memory bank processes and stores the intermediate results related to a specific set of tokens, thereby significantly reducing the amount of data transferred between layers.

The multi-head attention (MHA) 108 is composed of H number of heads where the dimension Dis split across all heads. The scaled dot-product attention is then computed as follows:

$$Head ( / ) = attention ( Q , K , V ) = softmax ( QKT / √ D ) . V . \qquad ( 1 )$$

The output of the MHA 08 is the concatenation of the self-attention heads' outputs, followed by a linear layer. The feed forward (FF) layer includes two dense layers with a RELU activation in between. Newer transformer-based pre-trained language models, such as BERT and its variants adopt a configuration that includes solely the transformer encoder block and a classification output layer. This block is comprised of a cascaded set of L layers, followed by an FF layer, GELU activation function, and normalization layers. Similarly, the vision transformer (ViT) model also employs L encoder layers, followed by a multi-layer perceptron. The VIT model inputs are sequence vectors representing an image.

The transformer neural network model 100 is based on L layers of encoder and decoder blocks as shown in FIG. 1. The encoder 102 transforms the input sequence into a coherent continuous representation of tokens, which is subsequently processed by the decoder 104. As the decoder 104 executes, the decoder 104 iteratively generates a single output while incorporating the preceding outputs. The two main sub-blocks in the encoder 102 and decoder 104 are the multi-head attention (MHA) 108 and feed forward (FF) 112 layers. The MHA 108 layer implements the self-attention mechanism which has gained significant traction in sequence learning and natural language processing (NLP), particularly in scenarios where long-term memory is essential. The input to the MHA 108 layer (/∈RN×D) with N number of tokens, is first processed by three linear layers 126q, 126k, 126v. The linear layers 126 generate the query (Q∈RN×D), key (K∈RN×D), and value (V∈RN×D) matrices by multiplying the input matrix/by weight matrices (WQ∈RD×D), (WK∈RD×D), and (WV∈RD×D) respectively.

More specifically illustrated, FIG. 1 depicts the encoder 102 (L layers) and the decoder 104 (L Layers). Input embeddings 106 are sent to the MHA 108a layer, which is coupled to an add & norm layer 110a, which is coupled to a feed forward layer 112a and an add & norm layer 110b. The decoder 104 receives output embeddings 116 and includes an MHA 108b, which is coupled to an add & norm layer 110c. The decoder also includes another MHA 108c layer, another add & norm layer 110d, a feed forward layer 112b, and another add & norm layer 110e. the decoder then sends data to the linear layer 138b and to the softmax layer 132b for output.

The MHA 108 layer includes linear layers 126q, 126k, 126v, which are coupled to a scaled dot product attention module 128. The scaled dot product attention module may include a Q×K^{T} layer 130, a softmax layer 132a, and a S×V layer 134.

Embodiments of this stochastic computing (SC) may be configured to simplify computational complexity by utilizing extended sequences of individual bits to represent numerical values. By trading off precision and representation density, SC can achieve simpler logic design and lower power consumption. Consequently, it has received a lot of attention recently in fields such as image/signal processing, control systems, deep neural networks (DNNs), and general-purpose computing. A system utilizing SC typically encapsulates three main steps:

Datageneration and representation: SC employs extended independent bit-streams to represent real numbers probabilistically, with the occurrence rates of 1s and 0s within the streams representing the corresponding real values. Eq. (2) and (3) outline examples for stochastically representing two binary numbers.

$${X}_{1} = \frac{6}{10} \to {x}_{1} ( stoch . ) = 0110101101 \qquad ( 2 )$$

$${X}_{2} = \frac{4}{10} \to {x}_{2} ( stoch . ) = 1010010001 \qquad ( 3 )$$

Pseudo-random number generators like linear-feedback shift registers (LFSRs) are frequently employed to generate the stochastic numbers, but such methods are susceptible to random variations, leading to inaccurate computations. In some embodiments, stochastic representations can be obtained deterministically using a decoder or a look-up table (LUT) which eliminates the inaccuracies caused by random fluctuations or correlations between bit-streams.

Stochastic arithmetic functions: Stochastic computing performs computations by statistically manipulating input bit-streams. Most functions found in binary computing are also accommodated within SC. However, binary computing functions that usually entail complex digital circuits can be performed with SC using simple logic gates. For example, a multiplication operation can be computed by a single AND gate using the stochastic bitstreams. Multiplying the two numbers from Eq. (2) and (3) would be computed as follows:

$${X}_{1} \times {X}_{2} = {x}_{1} \& {x}_{2} = 001 \; 0000001 ( = 0.2 ) \qquad ( 4 )$$

The product of X₁ and X₂ is expected to yield a real value of 0.24, yet the bitwise AND operation of x₁ and x₂ produces a result of 0.2. Thus, SC can experience a degree of precision loss. Within embodiments provided herein of the ARTEMIS accelerator, such inaccuracies can be overcome.

Stochastic to binary number conversion: Stochastic numbers involve a storage overhead of O(2n) due to the necessity of representing an n-bit real value with 2n bits. To mitigate this overhead, operand storage in SC typically adopts the binary format, necessitating stochastic-to-binary (S_to_B) conversions of operands. Such conversions are often performed using a popcount (PC) unit, which tallies the number of 1's in a stochastic bitstream to derive the corresponding binary value. However, PC units present several challenges due to their high area, latency, and energy overheads. Embodiments of ARTEMIS provided herein employ a low-overhead technique for S_to_B conversions.

While some prior works have started to explore SC for conventional DNN acceleration, to the best of the knowledge, embodiments provided herein represent the first architecture that tailors SC for accelerating transformer neural network models.

A DRAM chip features a hierarchical architecture consisting of banks, subarrays, and tiles. Within each subarray, there exists a two-dimensional array of DRAM cells, each comprising an access transistor and a capacitor (1T1C). These subarrays are further divided into smaller tiles. The local bit-line, which encompasses multiple cells, is linked to an S/A that actively manipulates the charge while also serving as a row buffer. The baseline memory framework utilized in this work is Samsung's high-bandwidth memory (HBM), which has emerged as a leading memory solution for diverse computing platforms. HBM usually comprises several stacks where each stack consists of a 4-layer HBM chip, connected to the host CPU or GPU. These stacks consist of multiple DRAM slices positioned atop the base die and are linked via multiple through-silicon vias (TSVs), enabling significantly enhanced bandwidth and reduced access latency compared to traditional 2D DRAM configurations. Each chip is further divided into channels and each channel is composed of several DRAM banks.

A read operation in DRAM involves three distinct phases: pre-charge, activate, and restore. During pre-charge, bit-lines are set to Vdd/2. In the subsequent activate phase, bit-lines are released while the target cells are accessed. Charge is then distributed between the cell and bit-line parasitic capacitance. Following this, the S/A is engaged to detect and amplify the subtle voltage variation resulting from charge distribution. The amplified voltage variation is then restored to the target cells in the restore phase. In a write operation, S/As read and amplify data from the DRAM chip's internal bus, which is subsequently written to the target cells during the restore phase.

Memory-based computing systems have received significant attention from both industry and academia. Such systems can be broadly categorized into PIM and NMC architectures. PIM embeds logic directly within the memory arrays, allowing it to perform computations on the stored data without notable data movement. This is enabled through utilizing the inherent operations already performed within the memory arrays (e.g., read and write). Meanwhile, NMC integrates compute logic in proximity of the memory system. This can entail placing compute units in the HBM's logic die, in near-bank I/O or, more aggressively, in the near-subarray circuits inside the memory bank. Although NMC typically incurs a higher area overhead, it still reduces the necessity for data movement by performing computations closer to the data storage location, without altering the subarray and tile structure.

While DRAM-based in-memory computing has been widely explored, other memory technologies have also received attention. For example, recent studies have shown that some emerging nonvolatile memory technologies, including ReRAM, phase change memory, and spin-transfer torque magnetic RAM, possess capabilities extending beyond mere storage functions. These technologies exhibit the ability to perform logic operations, thus enabling their utilization for both computation and memory tasks and facilitating the development of PIM architectures. Accordingly, several previous works have proposed utilizing such technologies for accelerating DNNs, including CNNs, RNNs, and transformers. However, such architectures introduce a distinct set of challenges, e.g., ReRAM cells suffer from reliability issues related to endurance and retention. Embodiments provided herein therefore leverage the prevalent and ubiquitous DRAM technology for computational tasks while integrating PIM and NMC principles. This integration enables rapid and energy-efficient acceleration of transformer neural networks.

In-DRAM PIM computing approaches integrate processing units within DRAM subarrays, leveraging the inherent mechanism of a DRAM read operation, discussed earlier. Through the utilization of RowClone, data transfer between different DRAM rows is achieved by concurrently activating the target row while restoring data to the original row. This process involves two consecutive activations followed by the pre-charge stage, known as the activate-activate-precharge (AAP) primitive. Each AAP cycle corresponds to one memory operation cycle (MOC). Subsequent studies have expanded upon this approach to incorporate fundamental compute functions within DRAM subarrays. For instance, Ambit concurrently activates three DRAM rows to execute bulk bitwise AND and OR operations in 3 MOCs, while ROC employs only two DRAM rows with an additional diode placed between two bit-cells situated on the same bit-line. This allows ROC to perform AND and OR operations in only 2 MOCs.

Memory-based PIM hardware accelerator designs have been extensively explored for traditional DNNs such as CNNs. Nevertheless, extending such architectures to transformer models can be inefficient. This is due to two main aspects inherent to transformer models: the unique and intensive computations within the transformer layers, and the massive amount of data that needs to be moved between those layers. Conventional PIM systems implement arithmetic functions digitally. This involves breaking down the functions, such as multiplication, into several MOCs. A single MUL operation can require up to 1600 nanoseconds as described in DRISA. To assess the impact of such time-consuming operations on the overall transformers' computational execution time, a detailed analysis was conducted focusing on the computations performed within transformer layers in encoder-only and encoder-decoder architectures using the DRISA accelerator.

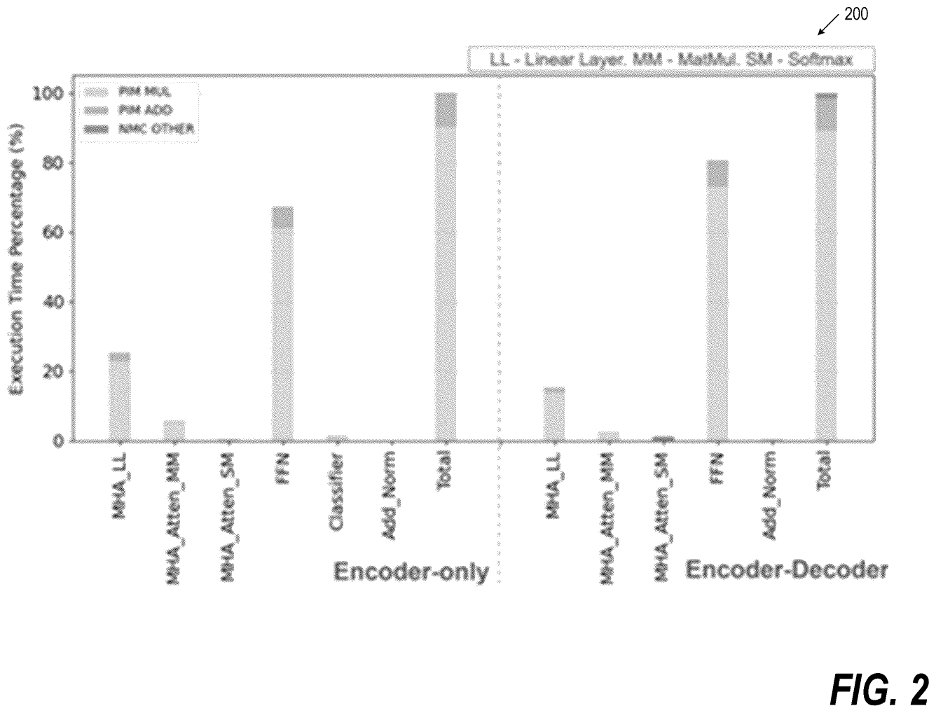

FIG. 2 depicts a component-wise analysis 200 for accelerating transformer neural network computations on traditional PIM architectures, according to embodiments provided herein. The results shown in FIG. 2 indicate that over 90% of the time spent on accelerating transformer computations is required by the DRAM arrays performing the MatMul operations in the MHA 108 and FFN 110 layers. This motivates optimizing the MatMul operations within PIM architectures as they can significantly impede the overall performance.

Prior efforts have attempted to address the MatMul bottleneck for DNN PIM acceleration. For example, a few previous works proposed using in-DRAM SC for accelerating CNNs. Such accelerators have demonstrated improvements over conventional PIM solutions. For example, SCOPE introduced a hierarchical and hybrid deterministic (H2D) SC arithmetic technique, capable of executing a single MAC operation in 200 nanoseconds. Another example is ATRIA which leverages bit-parallel stochastic arithmetic-based acceleration of MACs within modified DRAM arrays that can perform 16 MACs in 85 nanoseconds. Other efforts explored specifically accelerating a transformer's MAC operations using alternative technologies such as ReRAM-based memory architectures, as in ReBERT. However, as discussed above, leveraging ReRAM cells for PIM acceleration can present challenges. Conversely, ARTEMIS tailors in-DRAM SC for transformer models by combining PIM and NMC while utilizing SC for multiply operations and analog-based computations for accumulation operations. This results in significantly outperforming the underlying computational capability of previous efforts by enabling 64 MAC operations in only 48 nanoseconds in each subarray.

It should be noted that optimizing transformer neural network computations without sufficient optimizations for dataflow and software scheduling can still considerably limit improvements with PIM. Accordingly, ARTEMIS not only focuses on optimizing the execution of a transformer's computations but also on efficiently improving and reducing the latency involved with inter-bank and intra-bank data communication. Memory-based systems tailored for conventional DNNs usually employ optimizations in the software layer aimed at maximizing parallelism only. Accordingly, a layer-based data flow scheme is used to allocate sufficient memory resources based on the computations in each layer. This approach necessitates loading the entire data to be processed before each layer begins executing. Previous works outlined how such approaches when extended to transformers can result in most of the execution time being spent on data handling (movement, loading, re-organization, etc.). In some embodiments, employing a token-based dataflow has been proven more efficient when accelerating transformer models. This entails mapping the transformer computations to the memory-based system based on a token-sharding mechanism. TransPIM initially introduced such an approach where it implemented the token-based dataflow for transformer models in its software substrate. Another accelerator that elaborates on the advantages of such a scheduling approach is HAIMA (hybrid acceleration-in-memory architecture) where a hybrid SRAM (static random access memory) DRAM (dynamic random access memory) architecture is used for the various MatMuls and data movements of their outputs. Embodiments provided herein adapt and enhance the token-based dataflow to this stochastic-analog computational flow for efficient inter-bank data movement while also implementing an energy-efficient intra-bank data movement micro-architecture.

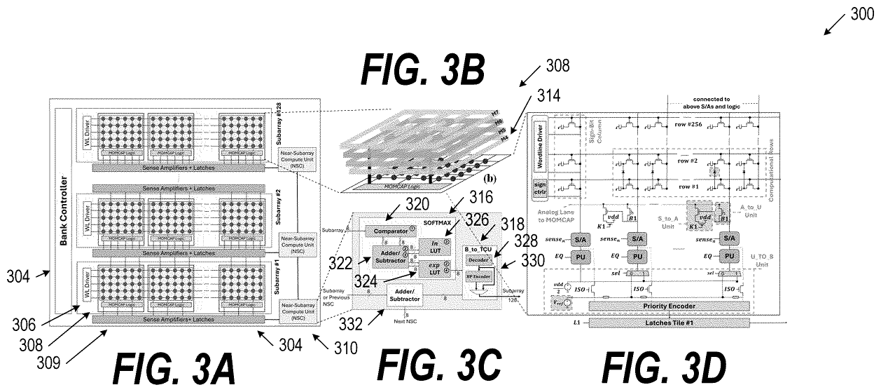

FIGS. 3A, 3B, 3C, 3D depict an ARTEMIS architecture 300 showing ]design of a single bank composed of 128 subarrays, each with 32 tiles (FIG. 3A), schematic layout of MOMCAP using metal layers (M4-M7) (FIG. 3B), structure of the first NSC unit (FIG. 3C), and structure of the first tile (FIG. 3D), according to embodiments provided herein. As illustrated, these embodiments relate to an in-DRAM transformer accelerator, ARTEMIS. Within an 8 GB HBM module, these embodiments implement a small number of modifications to the conventional DRAM bank and subarray architectures, as shown in FIG. 3A. In the DRAM tiles 308, these modifications involve incorporating small circuits (indicated in orange in FIG. 3D) and integrating a MOMCAP 314 atop each tile 308 as shown in FIG. 3B. Additionally, within each DRAM bank 306, a near-subarray compute unit (NSC) 310 is introduced for every subarray, comprising basic digital circuits and LUTs. The transformer layer operations are realized through three main computations, namely MAC, analog-to-binary conversion (A_to_B), and near-subarray computation. These embodiments follow a hardware-software co-design approach and integrates several dataflow and scheduling optimizations, allowing the embodiments to efficiently exploit the HBM's parallelism and also overcome intra-memory data movement bottlenecks. FIG. 3A also provides that each DRAM bank 306 includes a wordline (WL) driver 306. A bank controller 304 oversees and controls all of the DRAM Banks 306.

While SC reduces the overall number of MOCs necessary for MAC operations during multiplications, it introduces considerable challenges related to output precision. Several previous SC-based accelerators for conventional neural network acceleration have attempted to tackle this issue. For example, the utilization of SCOPE's H2D SC arithmetic, which incorporates computational S/As, has been shown to enhance CNN inference accuracy; however, it comes with a notable increase in area overhead. ATRIA addresses stochastic multiplication inaccuracies by increasing the bit width required for stochastic representation, at the expense of reducing parallelism. Another approach in designing the stochastic multiplier to utilize transition-coded unary (TCU) numbers for realizing bit-parallel deterministic stochastic multiplications, resulting in a reduction of computational errors by up to 32.2%. However, the implementation requires the integration of additional circuits and logic gate arrays.

In contrast to relying on a multiplier circuit like the one described in, embodiments provided herein introduce deterministic stochastic multiplication utilizing TCU numbers within the DRAM bit-line logic. TCU numbers are stochastic bit-streams where all the ‘1’s are grouped at either of the stream's trailing ends. This approach eliminates the need for additional circuitry within DRAM tiles, enabling the exploitation of parallelism while minimizing area overhead and mitigating SC multiplication inaccuracies.

Initially, the transformer layer parameters are distributed across ARTEMIS subarrays. When performing multiplications, to ensure accurate operation of the deterministic multiplication method, the first operand is generated using a binary-to-transition-coded-unary (B_to_TCU) decoder, followed by a bit-position correlation encoder, while the second operand is generated using a B_to_TCU decoder only. Each multiplication operation involved in the MatMuls in a transformer's MHA 108 and FF layers 110 (FIG. 1) is then performed stochastically.

Illustrated in FIG. 3C, the NSC 310 may include a softmax module 316 and a B_to_TCU module 318. The softmax module 316 may include a comparator 320, an adder/subtractor 322, an In SUT module 324, and an exp LUT module 326. The B_to_TCU module 318 may include a decoder 328 and a BP encoder 330. Also included in the NSC is an adder/subtractor 332.

In contrast to previous stochastic in-DRAM transformer accelerators, which require multiple MOCs or complex multiplier circuits, embodiments provided herein compute one multiplication operation by executing only two MOCs to copy the operands into two distinct computational rows. This is achieved by extending the method in for fast and energy-efficient SC logic operations where ARTEMIS reserves the entire first two rows in each subarray for SC multiplications. As shown in FIG. 3D, these two rows are connected with diodes between each pair of bit-cells and the AND result is thus computed and stored in the first computational row. A read operation is subsequently performed by pre-charging the bit-lines using the EQ signal which controls the pre-charge unit (PU). Computational row #1 is then activated by asserting WL_{comp_row1}, and enabling the S/As using the senseₙ signal.

The baseline memory architecture may incorporate an open-bit-line approach where only half of each DRAM bank's 306 subarrays are operated concurrently at a time. Thus, as shown in FIG. 3A, each DRAM tile 308 is connected to two sets of S/As 309, where one half of the bit-lines (128 out of 256 columns) are operated using the S/As 309 set at the bottom, while the other half are connected to the set at the top. These embodiments represent signed 8-bit binary numbers as 128-bits stochastic streams plus 1 sign bit, which is captured using a per-subarray added bit-line column indicating the sign associated with the numbers stored in each row. Accordingly, each row in a tile 308 stores all positive or all negative numbers and each tile can process up to two multiply operations at a time.

Stochastic-based addition has been shown to introduce considerable errors. In pursuit of both accuracy and speed during addition operations, embodiments provided herein utilize analog accumulation facilitated by a MOMCAP within each DRAM tile in the HBM. ARTEMIS repurposes S/As 309 to convert the number of 1's in a stochastic product value into a proportional analog voltage on the MOMCAP. This serves to convert the stochastic product value into an analog representation. Multiple analog voltage values representing multiple different stochastic product values can be sequentially accrued on the MOMCAP via analog accumulation. The customized H-shaped MOMCAP, shown in FIG. 3B, optimizes capacitance without increasing the overall tile area of ARTEMIS. While prior research, such replaced conventional embedded-DRAM cell capacitors with similar MOMCAPs to extend retention times, ARTEMIS is the first in-DRAM design to incorporate MOMCAPs for in-DRAM analog computing purposes.

The capacitance of the MOMCAP is contingent upon the capacitor's area, which determines the maximum number of consecutive accumulations it can accommodate. A higher number of accumulations enhances performance by reducing the need for frequent data conversions. However, as MOMCAPs are constructed using metal layers (M4-M7), their area must align with that of the tile to prevent an increase in overall size. Thus, embodiments provided herein perform a detailed analysis to determine the maximum number of accumulations achievable with varying capacitance values. An appropriate area budget to support up to 20 consecutive accumulations for each MOMCAP was thus established.

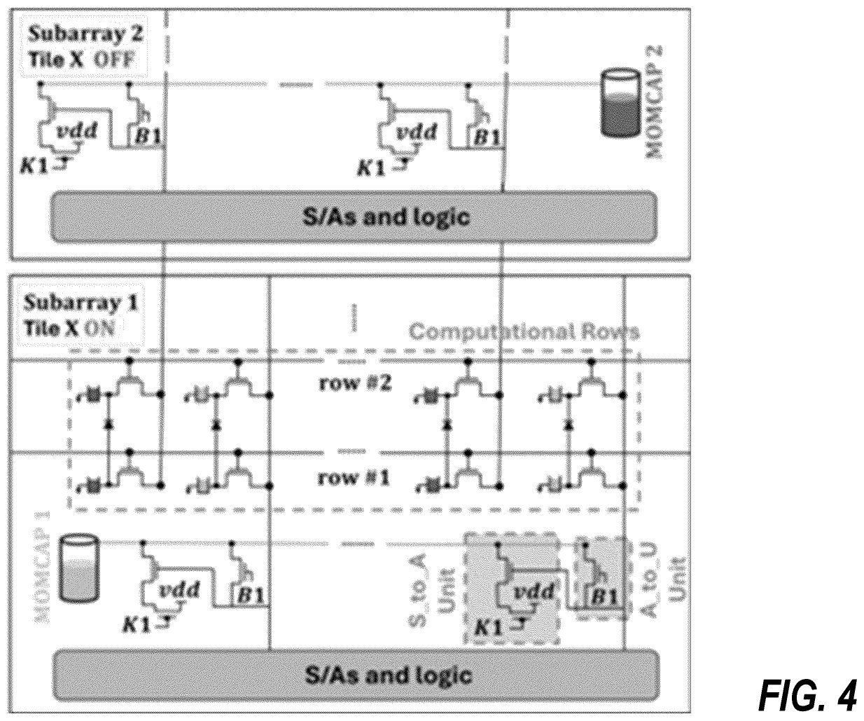

FIG. 4 depicts MOMCAPs charging during analog accumulation, according to embodiments provided herein. Within subarray 1 and subarray 2, each MOMCAP is connected to an analog lane which is connected directly to the S/A circuits 309, as shown in FIG. 3D. To enhance performance and achieve higher parallelism, each operational DRAM tile performing two multiplications at a time utilizes two MOMCAPs; its own as well as that of the non-operational DRAM tile above or below it as shown in FIG. 4. Accordingly, up to 40 MAC operations can be accommodated by each operational DRAM tile before requiring any data movement or conversions. The accumulation operation proceeds as follows: following one multiplication operation and storage of the output bits by the tile's S/As, each bit-line holds a value of ‘1’ or ‘0’. To convert this stochastic data into analog charge for accumulation on the MOMCAP, a stochastic-to-analog (S_to_A) circuit is implemented, comprising two transistors (FIG. 3D). This configuration supplies adequate voltage for the capacitor to detect all necessary voltage level changes. Upon toggling signal K₁, all bit-lines within the same tile connect to the two MOMCAPs (FIG. 4), resulting in two concurrent accumulations of charge, each directly proportional to the number of its connected bit-lines storing ‘1’ values. Subsequently, as the following sets of operands undergo multiplication, their two outputs are once again stored in the two MOMCAPS, effectively adding to the previous multiplication results.

The analog values preserved within each tile's MOMCAP require conversion into binary numbers for subsequent processing upon reaching the MOMCAP's charge capacity. ARTEMIS refines the circuits and timing signals from AGNI, achieving a reduced latency of 31 nanoseconds for the S_to_B conversion compared to AGNI's 56 ns. The enhanced S_to_A conversion circuit is described in the previous subsection. ARTEMIS employs a two-step process for analog-to-binary conversion: analog-to-transition-coded-unary (A_to_U) and transition-coded-unary-to-binary (U_to_B). Activation of the A_to_U circuit involves toggling control signal B1 to connect the stored MOMCAP value and the tiles' bit-lines. Subsequently, the S/As are repurposed as voltage comparators by pre-charging bit-lines to distinct voltage levels determined by the voltage divider circuit. The MUX sel signal controls the voltage divider circuit. This process yields A_to_U data conversion. Next, activation of the U_to_B unit is initiated by asserting the /SO signal, allowing the TCU number to traverse a priority encoder. Finally, each tile's binary result is latched for transmission to an NSC unit (discussed in subsection III.D).

The complete execution flow for computing 40 MAC operation followed by the A_to_B conversion step is realized in ARTEMIS via a per-tile vector multiplication programming model that is summarized in Algorithm 1 (lines 1-8) below.

Input: Input Vector /, Weight Vector W.
Output: Output Matrix O

| | |
|---|---|
| 1: | for each [iᵢ, iᵢ₊₁] in I: |
| 2: | for each [wᵢ, wᵢ₊₁] in W: |
| 3: | MUL([iᵢ, iᵢ₊₁], [wᵢ, wᵢ₊₁]) |
| 4: | ACC( ) |
| 5: | mac_cnt ← mac_cnt + 2 // increment MACs' counter by 2 |
| 6: | if (mac_cnt > 40 or final_iteration): |
| 7: | A_to_B( ) |
| 8: | mac_cnt ← 0 // reset MACs' counter |
| 9: | MUL([x₁, x₂], [y₁, y₂]) : // 34ns |
| 10: | row_{comp1} ← copy([x₁, x₂]) |
| 11: | row_{comp2} ← copy([y₁, y₂]) // output is stored in row_{comp1} |
| 12: | ACC( ) : // 14ns |
| 13: | Activate(row_{comp1}) |
| 14: | // store x₁ × y₁ is in lower S/As, x₂ × y₂ is in upper S/As |
| 15: | senseₙ ← 1 |
| 16: | K1 ← 1 // S/As outputs are accumulated in lower and upper |
| | MOMCAP |
| 17: | A_to_B( ) : // 17ns |
| 18: | sel ← 1 // repurpose S/As as comparators |
| 19: | B1 ← 1 // perform A_to_U by connecting MOMCAP to S/As |
| 20: | /SO ← 1 // perform U_to_B by passing unary number through PE |
| 21: | L1 ← 1 // Latch binary output to start moving it to NSC |

The algorithm utilizes three main user-defined functions (UDFs). MUL([x₁, x₂], [y₁, y₂]), defined in lines 9-11, takes as input the row addresses of two sets of operands: [x₁, x₂] and [y₁, y₂] where the first operands in each set are expected to be stored in the same tile row. The multiplication results (x₁×y₁, x₂×y₂) are then computed stochastically as previously explained. ACC( ) defined in lines 12-16, enables temporal analog accumulations by charging the two MOMCAPs relevant to that DRAM tile. Finally, after completing 40 MAC operations, A_to_B( ) defined in lines 17-21, is invoked to activate the two sets of A_to_U and U_to_B circuits. The steps and time durations for each UDF are also shown in Algorithm 1.

The NSC unit 309 is composed of simple digital circuits and LUTs with one NSC 309 assigned to each subarray. It handles the acceleration of the tiles' 308 partial sum accumulations, non-linear functions, and B_to_TCU data conversions.

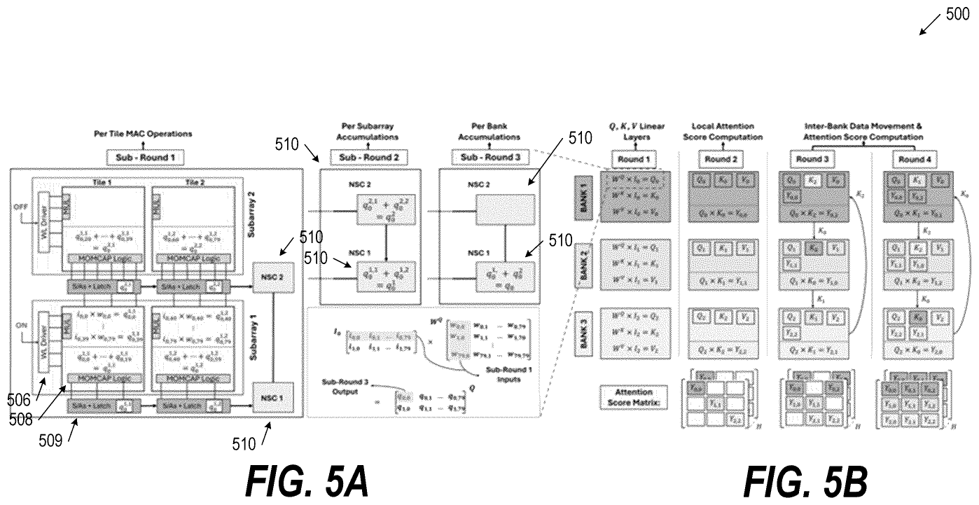

FIGS. 5A, 5B depict ARTEMIS dataflow scheme examples showing per-subarray vector multiplication flow with 2 subarrays and 2 tiles (FIG. 5A), token-based dataflow scheme for computing attention scores in MHA layers with 3 banks (FIG. 5B), according to embodiments provided herein. Following the computation of 40 MAC operations as explained above, each tile in the bank may have a partial sum output stored in its local latches. All the tiles' partial sums need to thus be gathered and reduced. Each subarray's NSC unit 510 is equipped with a 2-input 8-bit binary adder/subtractor to handle the partial sum accumulations. Embodiments provided herein may be configured for intra-bank data movement scheme applied in ARTEMIS to efficiently handle transferring all the tiles' data to the NSC units 510. Each subarray's NSC 510 is responsible for accumulating all the partial sums computed in that subarray. Additionally, each NSC 510 manages the accumulation of the output from the NSC unit 510 following it, as illustrated in FIG. 5A. In the example used in FIG. 5A, NSC 1 510 and NSC 2 510 first accumulate all the values output from their respective subarrays in sub-round 2. Afterwards, NSC 1 510 receives and accumulates the resultant output from NSC 2 501 in sub-round 3. To accommodate both positive and negative numbers, ARTEMIS performs MAC operations initially for all positive numbers (identified by the sign-bit column), consolidating the final positive result at each subarray's NSC unit 510. This process is then repeated for negative numbers, with their result subsequently subtracted from the positive result previously gathered using the same adder/subtractor block in each NSC 510.

Each NSC unit 510 is equipped with reprogrammable LUTs to handle fast execution of non-linear functions. Non-linear functions such as ReLU (used in FFN layers) and GELU (used in ViTs) can be realized using stand-alone LUTs. However, the softmax function that is frequently required in each head of the MHA layers, poses two main challenges. First, as expressed in Equation (5) below, softmax involves computationally expensive division and numerical overflow operations. Second, exploiting parallelism is a non-trivial task since all results from the previous MatMul need to be generated first before computing the softmax output for each value. To overcome both challenges, the log-sum-exp approach was employed, used in various previous works such as shown in the equation:

$$Softmax ( {y}_{1} ) = \frac{exp ( {y}_{i} - {y}_{max} )}{{\sum }_{j = 1}^{D} exp ( {y}_{j} - {y}_{max} )} = exp ( {y}_{a} - {y}_{max} - ln {\sum }_{j = 1}^{D} exp ( {y}_{j} - {y}_{max} ) \qquad ( 5 )$$

This allows us to divide the softmax execution into four main operations: (1) finding yₘₐₓ; (2) performing ln

$$( {\sum }_{j = 1}^{D} exp ( {y}_{j} - {y}_{max} ) ) ;$$

(3) subtracting (ln) output from (yᵢ−yₘₐₓ), and; (4) performing the final (exp) function. As the Y matrix is being generated from the MatMul preceding the softmax operation (QK^{T}) in the scaled dot product attention block, the output yᵢ is fed directly to a 2-input 8-bit comparator with a local register to hold the current yₘₐₓ, thus pipelining the execution of (1). Following the generation of matrix Y and storing yₘₐₓ in all NSC units, (2) is computed using the blocks labelled with “ ” in FIG. 3C. Subtraction (3) is then performed using the softmax adder/subtractor and finally, (4) is computed using the exp LUT. The orchestration of data movement and pipelining of softmax is further elaborated below.

The transformer's intermediate results are inputs to the next operations or layers. For example, the softmax output S in the MHAs scaled dot-product attention evaluation, is used to compute S×V (see FIG. 1). Accordingly, all values in matrix S need to be converted from binary to stochastic bitstreams to be used in stochastic multiplications. As explained in detail below, ARTEMIS uses a deterministic multiplication method, where the first operand is generated using a B_to_TCU decoder, followed by a bit-position correlation encoder, while the second operand is generated using a B_to_TCU decoder only. Thus, the B_to_TCU block in each NSC unit 510 comprises of a B_to_TCU decoder and a bit-position correlation encoder as shown in FIG. 3C. Depending on the order of the operand, the output of the B_to_TCU block will be that of the B_to_TCU decoder only or that of the bit-position correlation encoder. The bit-position correlation encoder ensures that the conditional probability of the 1st operand given the 2nd operand matches the marginal probability of the 1st operand.

To maximize HBM parallelism and overcome the data movement bottleneck when accelerating transformer models with a layer-based dataflow, embodiments may be configured to adapt a token-based data sharding dataflow, modified for its stochastic-analog computational flow.

In a transformer model, a sequence input is initially transformed into a series of input embeddings, where each embedding vector corresponds to a ‘token.’ Each token encapsulates specific features associated with the input sequence. Layer-based dataflow maps all the tokens to the same bank(s) responsible for computing the first transformer layer. All data output from the first layer is then transferred to the next bank(s) associated with performing the next layer's computations. Given the large number of model parameters in a transformer and the shared data bus of HBM, which allows only one bank to transfer its data at a time, this leads to significantly high congestion and data movement latencies.

In some embodiments, token-based dataflows map the data across the HBM banks based on input tokens. The primary advantage of employing token-based data sharding is the facilitation of data reuse across various layers by consolidating computations of tokens within the same memory location. This approach reduces the cost of data movement while capitalizing on memory-level parallelism, as different banks can independently handle computations and data movements for allocated tokens.

Following token sharding, each bank manages computations for its assigned segments throughout the entire transformer inference process. Token-based data sharding is implemented on input tokens before the linear layers of the initial encoder block. Accordingly, when the number of tokens, N, used in a model is greater than the number of banks, K, in the HBM module, each bank will operate on

$${N}_{b} = \frac{N}{K}$$

number of tokens.

To exploit the parallelism and performance improvements offered by the architecture's stochastic-analog computational scheme, ARTEMIS utilizes each tiles' row of latches and the NSCs to handle data being placed on or received from the HBM's links. Prior to transferring the banks' data to its neighboring bank, the stochastic output is converted to binary using the per-tile B_to_S circuits, which significantly reduces the number of bits transferred. Upon arrival to the neighboring bank, the data is first received by the NSC units where it is input to the B_to_S block. Using the per-tile latches rows, the stochastic numbers are then moved in a pipelined manner to the appropriate tiles where they are directly written to the target and computational rows to be used in the next computations. Accordingly, each of the subarrays may include a WL driver 506, MOCAP logic 508, and a S/A+latch 510.

FIG. 5B illustrates an example of processing the first linear layers (Q, K, V generation), and the attention score computation (Y=QK_{T}) in the MHA 108 layer. Initially the input matrix is distributed based on the token-sharding mechanism explained above, where each bank will operate on (/i∈R^{N}B^{×D}). In Round 1, each bank will generate its own local Qᵢ, Kᵢ, and Vᵢ, each with size N_{B}×D. Each bank then computes its local attention scores using the stored Qᵢ and Kᵢ, and by the end of Round 2, each bank will have generated the partial attention score matrix Y_{i,i}. To correctly generate the complete attention score matrix, each bank will need to transfer its own Kᵢ matrix to all other banks. Similar to TransPIM, a ring and broadcast network is utilized to minimize the latency cost of the data movement steps in Rounds 3 and 4. As each bank i receives the partial Kⱼ matrices from all the banks, it will keep on generating partial attention score matrices Y_{i,j} till all the values are computed in Round 3. The next steps in the MHA 108 layer entail the softmax operation and the attention output computation ((Sᵢ×Vᵢ). When performing the latter, rounds 2, 3 and 4 will need to be repeated as partial Vᵢ will also need to be exchanged between all the banks for correct operation.

FIG. 5A outlines the underlying operation flow in the bank 1 subarrays when generating one value in the Q matrix. In this example the dimension of Q is 80 and thus to calculate the first value, q_{0,0}, the first row from the partial input matrix /₀ needs to be multiplied by the first column in the query weight matrix W^{Q}. This results in vector multiplication with size 80.

As explained in section III.A, ARTEMIS follows an open-bit-line architecture where only half the subarrays in a bank are activated at a time. Accordingly, in the example in FIG. 5A, only one out of the two subarrays will be activated concurrently. For simplicity, assume that only subarray 1 is “ON” for all the vector multiplication operations. As discussed in detail below, each tile can perform 40 MAC operations before converting the accumulated analog value stored in the MOMCAPs 508 to binary values. Thus, tile 1 in subarray 1 will perform stochastic multiply operations using sub-vectors /₀[0: 39] and WQ[0: 39] and perform the analog temporal accumulations for multiply outputs 0 to 19 only. Meanwhile, tile 1 in subarray 2 will accumulate multiply outputs 20 to 39 using its own MOMCAP 508 and associated logic. Similar operations will be computed in tiles 2 in subarrays 1 and 2.

By the end of Sub-Round 1, each tile's binary partial sum output will be stored in the tile latches. These values will then be transferred to the NSC units 510 in a pipelined manner, until both values from each subarray reach the NSC 510 and are immediately added using the adder/subtractor circuit as shown in Sub-Round 2. The last step (Sub-Round 3) is then to move the partial sum output from NSC 2 510 to NSC 1 510 to be further reduced into q_{0,0}. Since the sign bits column corresponds to both values stored in each operational tile, in this example, NSC 1 510 is responsible for forwarding the sign bit to NSC 2 510 as well.

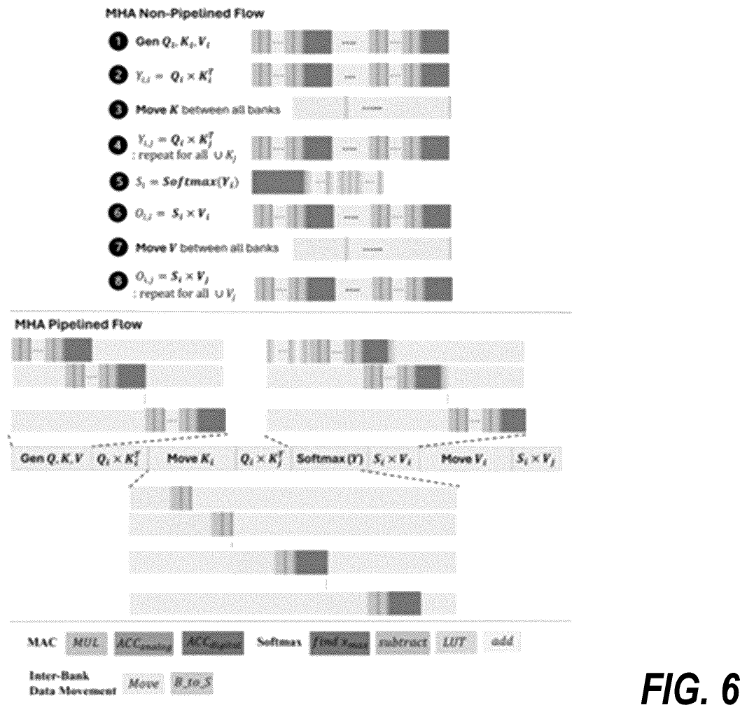

FIG. 6 depicts an ARTEMIS pipelining within one bank for MHA 108 layers, according to embodiments provided herein. To further exploit parallelism, ARTEMIS pipelines the transformers' operations. FIG. 6 outlines the pipelining model adopted by the architecture when accelerating an MHA layer in one bank. The MHA operations are divided into 8 steps as shown in the top half of FIG. 6. First, when generating the Qᵢ, Kᵢ, and Vᵢ matrices, ARTEMIS pipelines the following: (i) performing the in-situ MAC operations within the DRAM tiles, (ii) pipelining the data movement using the row of latches and (iii) accumulating the binary partial sums in the NSC units. As shown in FIG. 6, this efficiently hides the latencies associated with the intra-bank data movement and the NSC reduction operations. This pipelining scheme is applied when performing any MatMul operations in the MHA and FFN layers in the transformer's encoder or decoder blocks. After generating the local attention score partial matrix by computing

$${Q}_{i} \times {K}_{i}^{T} ,$$

each bank will need to send its local Kᵢ matrix to all other banks using the ring and broadcast technique discussed earlier.

While ARTEMIS significantly reduces the latencies associated with performing transformer operations, the interbank data movement step is predominately the most time consuming step based on the analysis. Nevertheless, the hardware accelerator mitigates the latency of this step by overlapping the inter-bank data movement with the B_to_S data conversions, softmax, and the next MatMul to be executed (Sᵢ×Vᵢ) as shown in the pipelined flow in FIG. 6. Data is transferred between banks in binary using a 256-bit link and as new data arrives to a bank, instead of first writing the value to the DRAM arrays, ARTEMIS directly passes it through the B_to_TCU blocks in the NSC units to prepare the stochastic multiplication operands. These values are then written in the tiles' computation rows to be used immediately in the MAC operations. Such optimizations not only result in faster execution but also reduce energy consumption associated with the eliminated DRAM write operations. As the attention score matrices are being generated in each bank, the output values are being input concurrently to the softmax 8-bit comparators to keep updating yₘₐₓ (see Equation (5)). Other softmax operations such as the subtractions and the final exponent calculation are also pipelined when computing (Sᵢ×Vᵢ) as shown in FIG. 6.

A comprehensive simulator was developed in Python to estimate the performance and energy costs of the proposed accelerator. The parameters of the HBM utilized by the architecture are as shown in Table I, based on 22 nm DRAM technology. The DRAM bank structure in the architecture is slightly re-arranged in comparison to previous work and conventional HBM architectures. Each subarray is comprised of only 256 rows, allowing for faster operation per subarray and higher parallelism. While this results in slightly increased area and power consumption, such organization is better aligned with stochastic-based computing.

Based on SPICE simulations, one MOC in ARTEMIS is equivalent to 17 nanoseconds. Moreover, the overall power budget for ARTEMIS is about 60 W, in alignment with the HBM conventional DRAM power budget. Four transformer model workloads were considered in all the experiments: Transformer-base, BERT-base, ALBERT-base, and ViT-base. Details of these models are shown in Table II. The DRAM array area estimates were obtained using CACTI-3D, while latency values were computed using detailed LTSPICE simulations. All circuits present in the NSC units, and the latches were synthesized using Cadence Genus and the obtained latency, power, and area values are as reported in Table III.

### Artemis HBM Configuration Parameters

TABLE I

| | Parameters | Value |
|---|---|---|
| Configuration | Number of HBM stacks | 1 |
| | Number of channels per stack | 8 |
| | Number of banks per channel | 4 |
| | Number of subarrays per bank | 128 |
| | Number of tiles per subarray | 32 |
| | Number of rows per tile | 256 |
| | Number of bits per row | 256 |

| | |
|---|---|
| Energy | e_{act} = 909 pJ, e_{pre-SGA} = 1.51 pJ/b, |
| | e_{Post-GSA} = 1.17/b, e_{l/0} = 0.80 pJ/b |

### Transformer Model Configurations

TABLE II

| Model | Params | Layers | N | Heads | d_{model} | d_{ff} |
|---|---|---|---|---|---|---|
| Transformer- | 52M | 2 | 128 | 8 | 512 | 2048 |
| base | | | | | | |
| BERT-base | 108M | 12 | 128 | 12 | 768 | 3072 |
| Albert-base | 12M | 12 | 128 | 12 | 768 | 3072 |
| ViT-base | 86M | 12 | 256 | 12 | 768 | 3072 |

### Artemis Per Subarray Hardware Overhead

TABLE III

| Component | Latency (ps) | Power (mW) | Area (μm²) |
|---|---|---|---|
| S_to_B Circuits | 20000 | 0.053 | 970 |
| Comparator | 623.7 | 0.055 | 0.0088 |
| Adder/Subtractors | 719.95 | 0.0028 | 0.0055 |
| LUTs | 222.5 | 4.21 | 4.79 |
| B_to_TCU Blocks | 530.2 | 0.021 | 0.063 |
| Latches | 77.7 | 0.028 | 0.13 |

Given that SC demands 2N bits for each N-bit binary number, neural network model compression, particularly through quantization, can enhance the overall performance. The analysis indicates that the utilization of 8-bit model quantization results in transformer inference accuracy levels comparable to those achieved with full precision (FP32), as depicted in Table IV. Consequently, embodiments include transformer models featuring 8-bit precision, where ARTEMIS represents parameter values stochastically with 128 bits plus one sign bit. Furthermore, error analysis was performed to assess the efficacy of the stochastic multiplication technique implemented in hardware, noting an average MAE of 0.077. When integrated into transformer model inference, the resultant accuracy drop was found to be minimal.

### Transformer Model Accuracies

TABLE IV

| Model | Dataset | FP32 | Q(8-bit) | Q(8-bit) + SC |
|---|---|---|---|---|
| Transformer-base | Ted-hrlr | 70.90% | 70.40% | 69.32% |
| BERT-base | GLUE | 87.00% | 86.27% | 85.90% |
| Albert-base | GLUE | 86.07% | 84.80% | 84.26% |
| ViT-base | ImageNet | 97.60% | 96.50% | 96.20% |

Table IV presents the inference accuracies for the models employed in the experiments, for the baseline FP32, quantized 8-bit precision, and quantized 8-bit precision with SC multiplications cases. Through the avoidance of stochastic additions and the adoption of an optimized approach to stochastic multiplications, ARTEMIS demonstrates minimal accuracy degradation, averaging at 1.4% compared to FP32 and 0.5% compared to quantized 8-bit models.

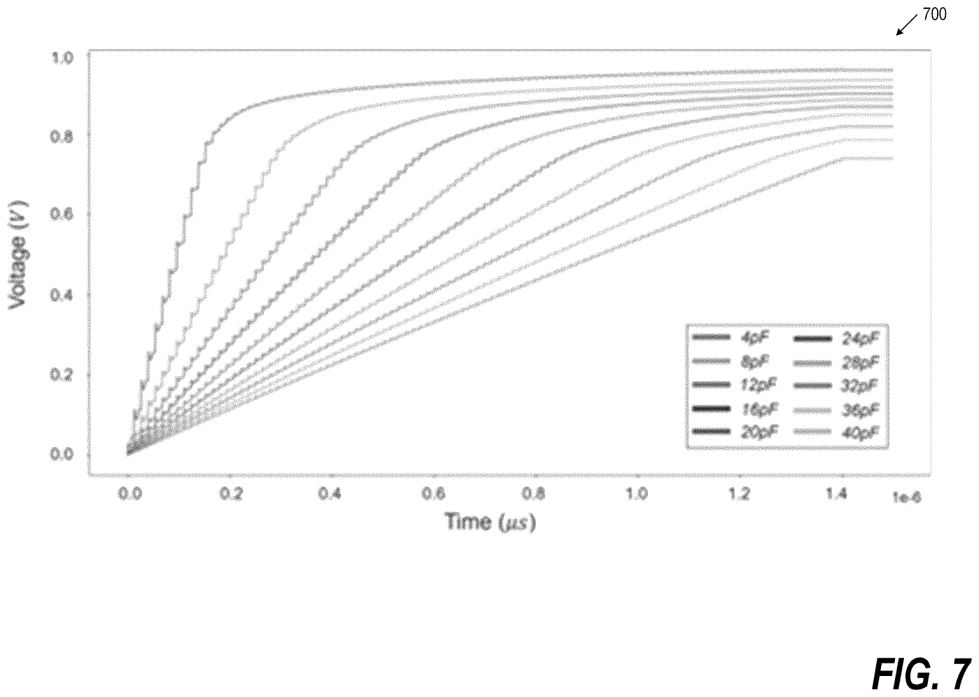

FIG. 7 depicts ARTEMIS experimental results for MOMCAP voltage behavior when storing multiple consecutive accumulations of 128-bit numbers from the DRAM tile bit-lines 700, according to embodiments provided herein. To determine the optimal parameters for the custom MOMCAP within the DRAM tiles, 128 bit-lines were modeled and simulated alongside the tile's circuits (shown in FIG. 3D) utilizing LTSPICE. Through this process, the voltage behavior of charge accumulation on the MOMCAP was analyzed across a spectrum of capacitance values, ranging from 4 pF to 40 pF, which are distinguished by various colors in FIG. 7. The linearity and symmetry observed in the steps of charge accumulation on the MOMCAP denote its stable performance and its ability to accurately differentiate between distinct voltage levels. Based on the detailed experimental and numerical analysis, such behavior was a result of accurately controlling the charging time of each step, which was set to 1 nanosecond. Each voltage increment in the graph represents the accumulation of a 128-bit number. Consequently, the maximum number of accumulations corresponds to the number of linearly increasing voltage steps until saturation occurs.

As depicted in FIG. 7, increased capacitance enhances the capacitor's ability to accommodate a greater number of accumulations. Nonetheless, as previously outlined, higher capacitance leads to a larger area overhead. Hence, a MOMCAP size aligning with ARTEMIS' tile area of 338 μm2 was selected, which corresponds to an 8 pF capacitance. This selection enables the accumulation of 20 consecutive dot products per MOMCAP.

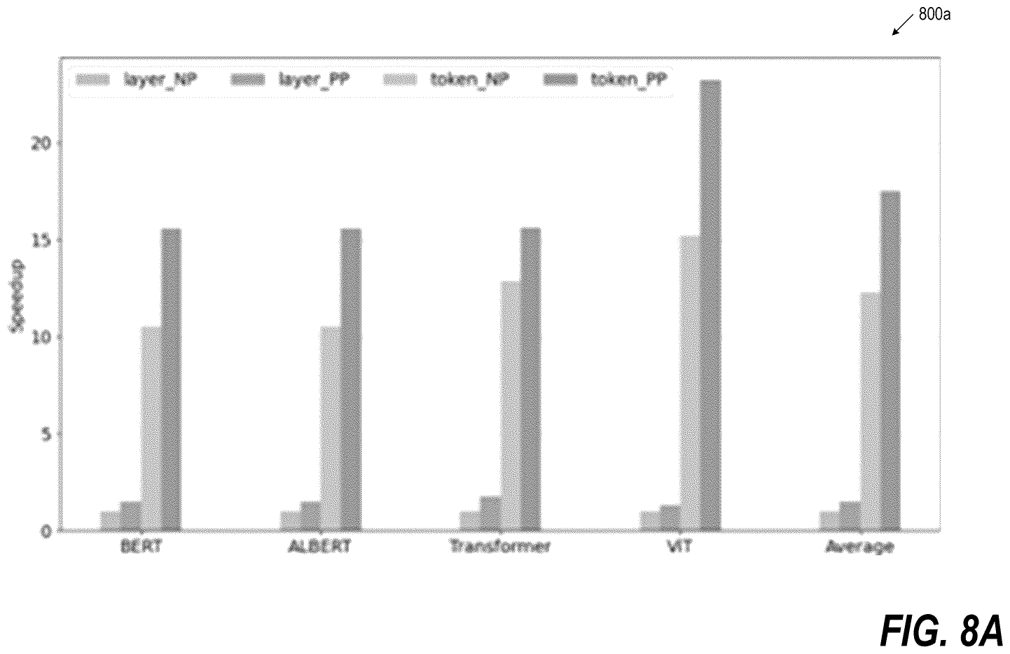

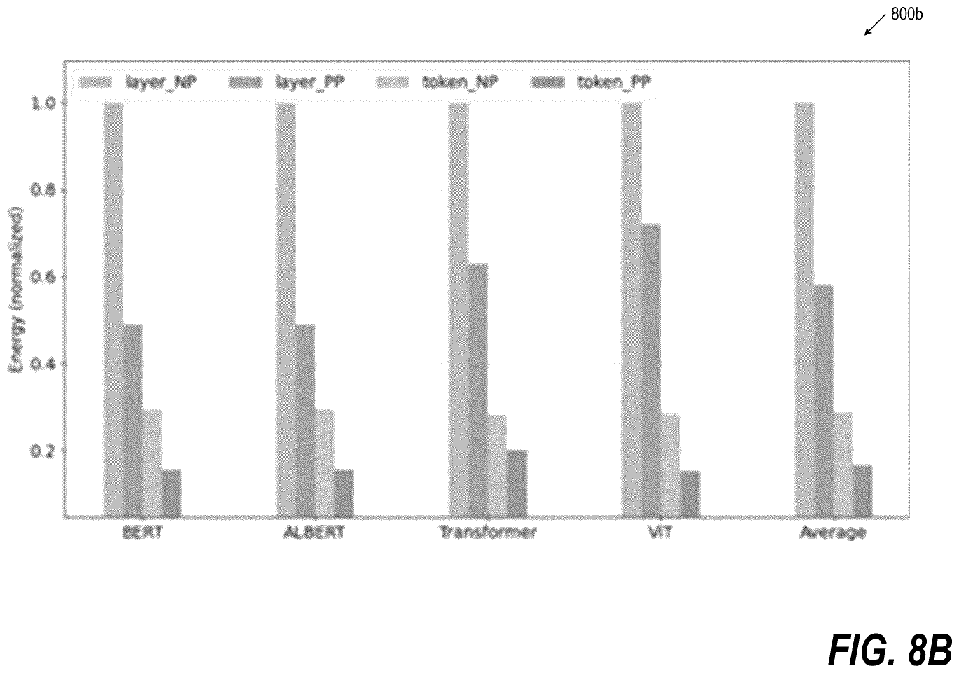

A sensitivity analysis was conducted to assess the impact of the dataflow and execution pipelining optimizations described in Section III.E. The speedup and normalized energy results are shown in FIGS. 8A and 8B, respectively. The results were obtained for executing the four transformer models on ARTEMIS but using a layer-based dataflow scheme without pipelining (layer_NP), a layer-based dataflow with pipelining enabled (layer_PP), a token-based dataflow without pipelining (token_NP), and finally the main ARTEMIS architecture with token-based dataflow and execution pipelining (token_PP).

Despite HBM offering a bandwidth of up to 256 GB/s per stack, the shared data link and the massive amount of values that needs to be moved between the different transformer layers vastly limit the acceleration of transformers on PIM systems. On the other hand, utilizing the token-based data sharding dataflow results in an average speedup of 12.3× without pipelining enabled and 11.5× when pipelining is enabled in both dataflow schemes. As shown in FIG. 8B, employing the token-based dataflow is also more energy efficient since the amount of data movement is reduced. An average energy reduction of 3.5× is observed without pipelining and also with execution pipelining enabled. Pipelining also has an impact on speedup and energy since ARTEMIS efficiently pipelines various operations within each layer. The energy reduction is also due to avoiding unnecessary write operations when receiving new data from neighboring banks. On average, pipelining results in a speedup of 50% with the layer-based dataflow and 43% with the token-based dataflow. For energy consumption, pipelining results in 72% energy reduction with the layer-based dataflow and 74% reduction with token-based dataflow. The impact of pipelining and the token-based dataflow was greatest when accelerating ViTs. This is partly due to the longer input sequences used with the ViT model in the experiments. This indicates promising scalability results that can be exhibited with ARTEMIS which is further elaborated on in section IV.E.

FIGS. 8A, 8B depict an example sensitivity analysis showing the impact of token-based dataflow and execution pipelining on speedup 800a (FIG. 8A) and energy 800b (FIG. 8B), according to embodiments provided herein. ARTEMIS was compared with CPU, GPU, TPU, and several state-of-the-art PIM transformer accelerators: TransPIM, HAIMA, and ReBERT. It will be noted that ReBERT only focuses on BERT-based models. Power, latency, and energy values were reported for the selected accelerators, and directly obtained results from executing models on the GPU, CPU, and TPU platforms to estimate the energy, power efficiency, and inference latency for each model and dataset.

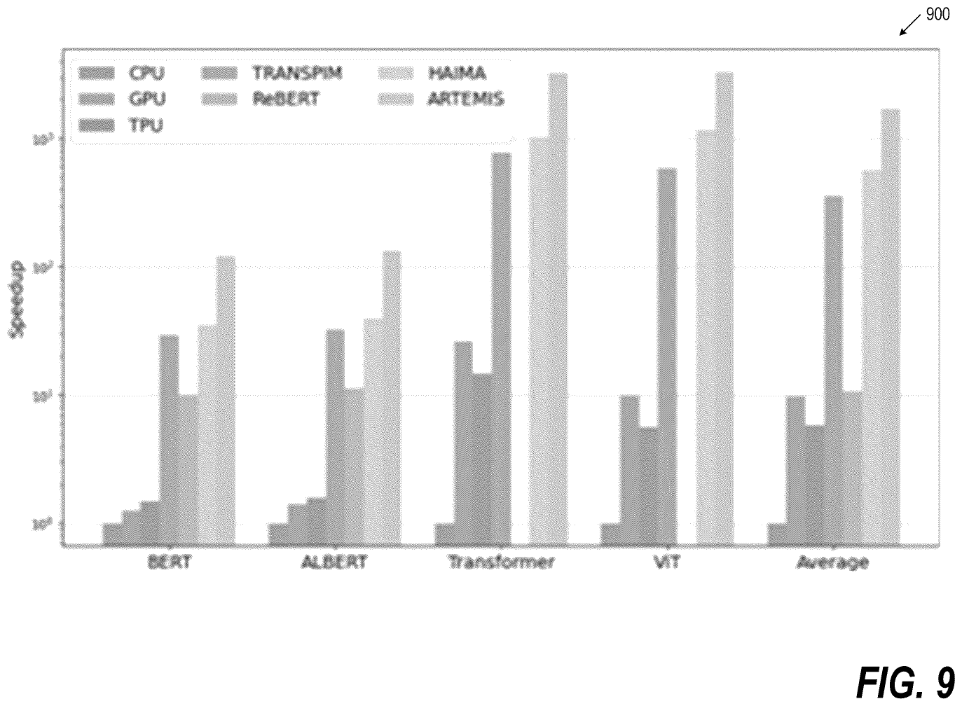

FIG. 9 depicts example speedup comparison between ARTEMIS, CPU, GPU, TPU and PIM accelerators 900, according to embodiments provided herein. FIG. 9 shows the speedup comparison between ARTEMIS, the compute platforms, and the transformer PIM accelerators considered. The speedup values are all relative to the CPU inference latency. On average, ARTEMIS achieves 1486×, 154×, 230×, 4.3×, 11.9×, and 3.0× speedup compared to CPU, GPU, TPU, TransPIM, ReBERT, and HAIMA, respectively. The lower latencies observed with ARTEMIS can be attributed to its ability to perform 64 MAC operations in only 48 nanoseconds using SC and analog-based computing. Furthermore, the optimized data mapping, movement, and scheduling schemes aided in reducing the overall latency.

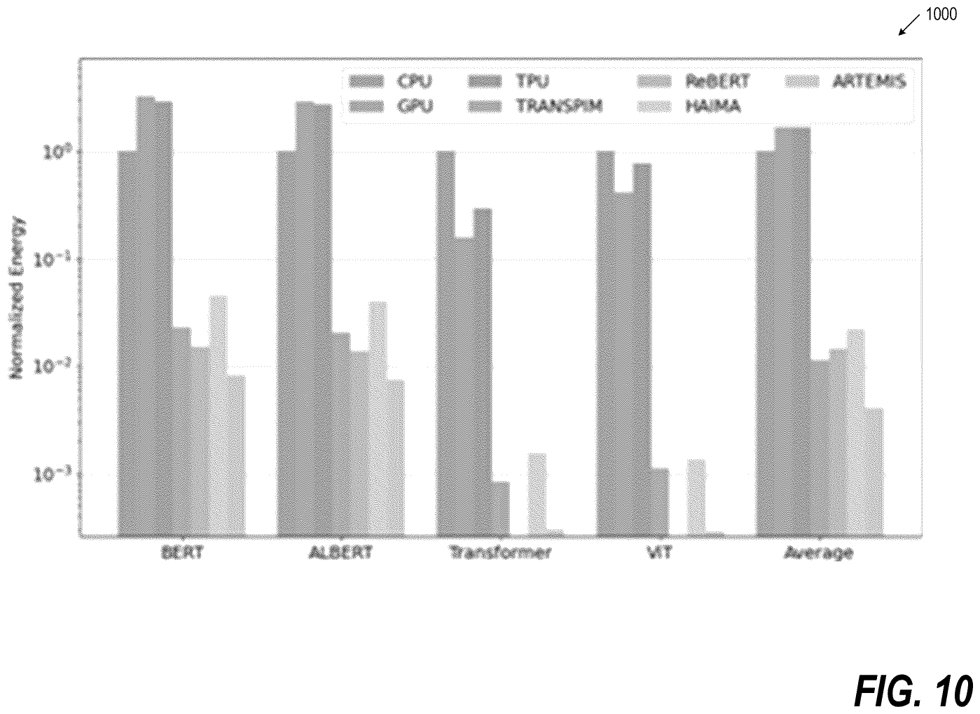

FIG. 10 depicts an example energy comparison between ARTEMIS, CPU, GPU, TPU and PIM accelerators 1000, according to embodiments provided herein. The energy comparison results for ARTEMIS with the computing platforms and transformer PIM accelerators considered are shown in FIG. 10. All the energy values are normalized to the CPU. ARTEMIS achieved on average 1747.0×, 686.8×, 1084.8×, 3.0×, 1.8×, and 5.2× lower energy values compared to CPU, GPU, TPU, TransPIM, ReBERT, and HAIMA, respectively. The reduced energy consumption observed with the architecture can be explained in terms of the significantly reduced number of required DRAM row activations when accelerating transformers' predominant computations, namely MACs. This results from SC enabling the compute-intensive multiplication operations to be realized using simple in-DRAM AND operations along with the MOMCAP analog compute logic facilitating fast and energy-efficient temporal analog accumulations.

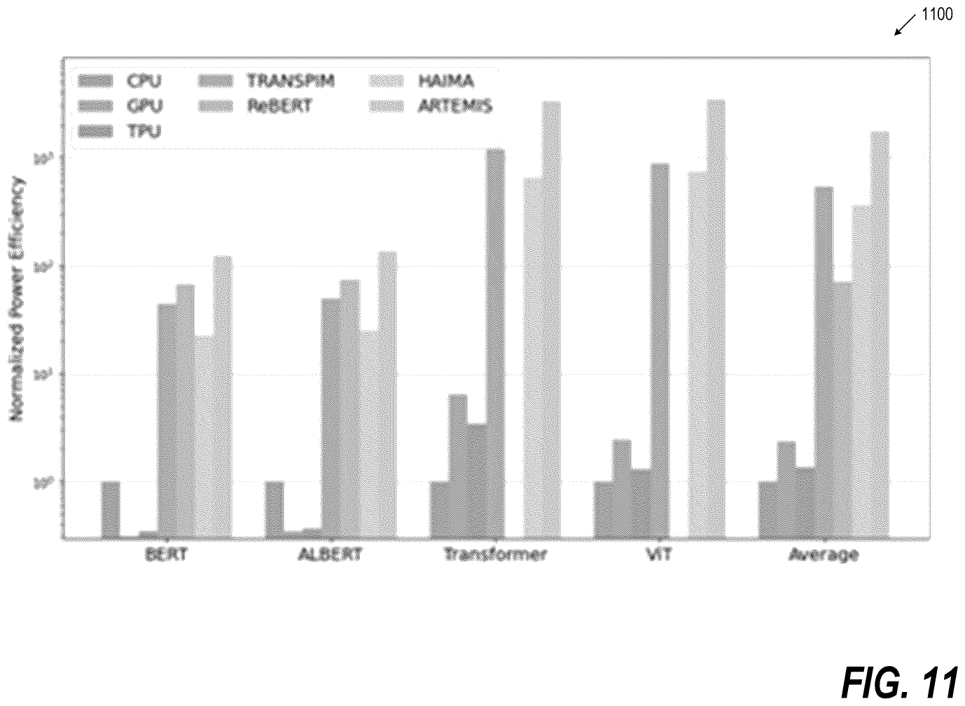

FIG. 11 depicts an example power efficiency (COPS W) comparison between ARTEMIS, CPU, GPU, TPU and PIM accelerators 1100, according to embodiments provided herein. FIG. 11 shows the power efficiency results (in terms of GOPS/Watt values) when comparing ARTEMIS to all other compute platforms and PIM accelerators. The accelerator attains on average 1529.3×, 653.3×, 1022.0×, 2.7×, 1.9×, and 4.8× improvement compared to CPU, GPU, TPU, TransPIM, ReBERT, and HAIMA, respectively. The enhanced power efficiency of ARTEMIS is due to its notable low per-MAC latency, and the overall high throughput operation while abiding by a maximum power budget of 60 W. Moreover, by employing the various compute, data movement, and orchestration optimizations explained earlier, the architecture has the ability to efficiently accommodate all the various transformer models' operations using minimal added circuitry. This in turn, significantly improves the power efficiency.

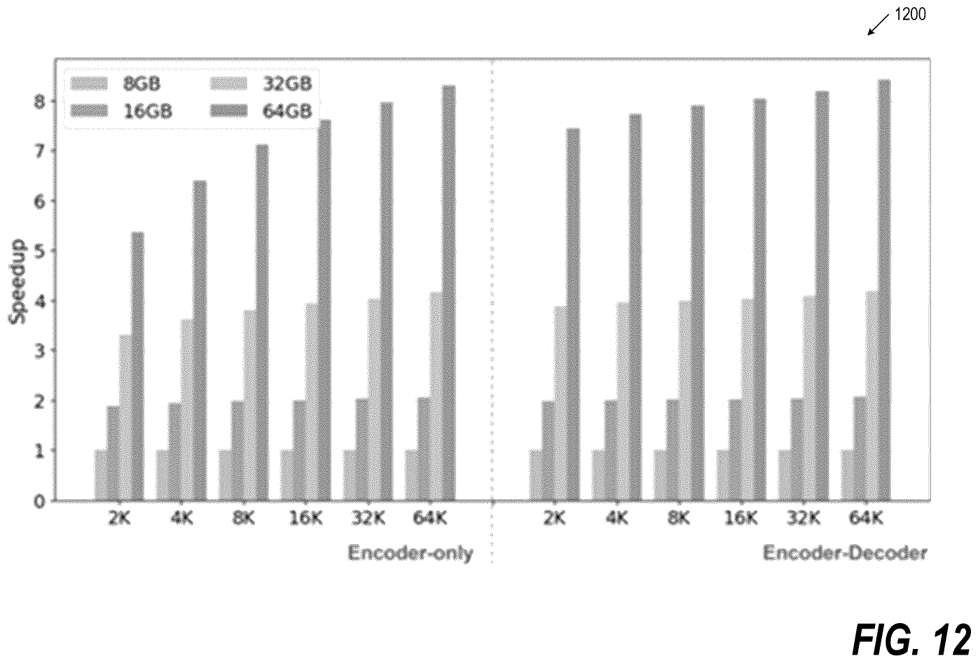

FIG. 12 depicts an ARTEMIS scalability analysis 1200 when increasing the input sequence length for transformer neural network models, according to embodiments provided herein. Transformer models usually encounter considerable challenges when handling long input sequences. Conventional compute platforms such as CPUs, GPUs, and TPUs are constrained by the sequence length due to their limited available memory capacity. Meanwhile, PIM-based systems present a promising avenue for scalability, offering the potential for enhanced memory bandwidth while concurrently increasing parallelism with minimal memory access latency. Illustrated in FIG. 12 are the speedup outcomes obtained by employing additional HBM stacks for processing workloads of increasing input sequence lengths. The speedup results, averaged across all transformer models used, demonstrate that ARTEMIS exhibits commendable scalability, approaching near-linear performance enhancement for extended sequence workloads that fully utilize the computational capabilities of HBM. These and previous experimental findings strongly suggest that combining concepts of stochastic and analog computing in PIM systems while utilizing optimized dataflow schemes enable a viable and efficient solution for accelerating long-sequence transformer applications.

Embodiments provided herein may advance the technology of neural networks by providing an in-DRAM hardware accelerator by combining principles of stochastic and analog computing, to accelerate multiple existing variants of transformer neural networks. Some embodiments provide an in-DRAM analog accumulation unit using a custom metal-oxide-metal capacitor (MOMCAP). These embodiments may combine dataflow and control mechanisms and implement intra-and inter-bank microarchitectures to reduce data movement latencies and energy overheads. These embodiments provide a comprehensive comparison with GPU, TPU, CPU, and several state-of-the-art PIM transformer neural network accelerators. Some embodiments include a novel in-DRAM hardware accelerator for transformer neural networks that combines stochastic and analog computing and extends state-of-the-art HBM architectures. Embodiments of the architecture demonstrate remarkably low per-MAC latency through the utilization of bit-parallel stochastic computing for multiplications, coupled with analog domain accumulations. ARTEMIS exhibited at least 3.0× speedup, 1.8× lower energy, and 1.9× better power efficiency when compared to GPU, TPU, CPU and multiple state-of-the-art PIM transformer accelerators. The results demonstrate the promise of utilizing in-DRAM stochastic and analog computations for transformer neural network acceleration.

Various modifications of the present disclosure, in addition to those shown and described herein, will be apparent to those skilled in the art of the above description. Such modifications are also intended to fall within the scope of the appended claims.

It is appreciated that all reagents are obtainable by sources known in the art unless otherwise specified. It is also to be understood that this disclosure is not limited to the specific aspects and methods described herein, as specific components and/or conditions may, of course. vary. Furthermore, the terminology used herein is used only for the purpose of describing particular aspects of the present disclosure and is not intended to be limiting in any way. It will be also understood that, although the terms “first,” “second,” “third” etc. may be used herein to describe various elements, components, regions, layers, and/or sections, these elements, components, regions, layers, and/or sections should not be limited by these terms. These terms are only used to distinguish one clement, component, region, layer, or section from another element, component, region, layer, or section. Thus, “a first element.” “component,” “region,” “layer.” or “section” discussed below could be termed a second (or other) clement, component, region, layer, or section without departing from the teachings herein. Similarly, as used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. The term “or a combination thereof” means a combination including at least one of the foregoing elements.

Unless otherwise defined, all terms (including technical and scientific terms) used herein have the same meaning as commonly understood by one of ordinary skill in the art to which this disclosure belongs. It will be further understood that terms such as those defined in commonly used dictionaries, should be interpreted as having a meaning that is consistent with their meaning in the context of the relevant art and the present disclosure, and will not be interpreted in an idealized or overly formal sense unless expressly so defined herein.

Reference is made in detail to exemplary compositions, aspects and methods of the present disclosure, which constitute the best modes of practicing the disclosure presently known to the inventors. The drawings are not necessarily to scale. However, it is to be understood that the disclosed aspects are merely exemplary of the disclosure that may be embodied in various and alternative forms. Therefore, specific details disclosed herein are not to be interpreted as limiting, but merely as a representative basis for any aspect of the disclosure and/or as a representative basis for teaching one skilled in the art to variously employ the present disclosure.

Patents, publications, and applications mentioned in the specification are indicative of the levels of those skilled in the art to which the disclosure pertains. These patents, publications, and applications are incorporated herein by reference to the same extent as if each individual patent, publication, or application was specifically and individually incorporated herein by reference.

This description is illustrative of particular embodiments of the disclosure, but is not meant to be a limitation upon the practice thereof. The following claims, including all equivalents thereof, are intended to define the scope of the disclosure.

1. A processing-in-memory (PIM) system for accelerating transformer neural networks, comprising:
a plurality of subarrays, each subarray of the plurality of subarrays including a plurality of DRAM tiles, wherein each subarray of the plurality of subarrays comprises:
a plurality of bitlines for performing stochastic multiplication operations;
a first metal-oxide-metal capacitor (MOMCAP) for accumulating analog values; and
a stochastic-to-analog (S_to_A) circuit for converting stochastic data into analog charge for accumulation on the first MOMCAP;
wherein the PIM system is configured to:
perform multiplication operations on input vectors and weight matrices in the plurality of subarrays;
accumulate results of the multiplication operations on the first MOMCAP; and
convert the analog accumulated values to binary values.

2. The PIM system of claim 1, wherein the plurality of DRAM tiles includes a second MOSCAP that is disposed over the first MOMCAP.

3. The PIM system of claim 1, wherein each subarray of the plurality of subarrays includes a wordline (WL) driver.

4. The PIM system of claim 1, wherein each subarray of the plurality of subarrays is coupled to a near-subarray compute unit (NSC).

5. The PIM system of claim 4, wherein the NSC includes softmax logic, which includes a comparator and an adder/subtractor, and a binary-to-transition-coded-unary (B_to_TCU) decoder.

6. The PIM system of claim 4, wherein the PIM system accelerates deep neural networks while not requiring external high-bandwidth memory to receive data.

7. The PIM system of claim 4, wherein the PIM system accelerates deep neural networks with flexible support for various patterns and frequencies of data access and reuse without necessitating data to be presented in a specific access or reuse pattern.

8. The PIM system of claim 1, wherein each subarray of the plurality of subarrays is coupled to a sense amplifier and latches component.

9. The PIM system of claim 1, wherein each the plurality of subarrays is coupled together and controlled by a bank controller.

10. A processing-in-memory (PIM) system for accelerating transformer neural networks, comprising:
a plurality of subarrays, each subarray of the plurality of subarrays including a plurality of DRAM tiles, wherein each subarray of the plurality of subarrays comprises:
a plurality of bitlines for performing stochastic multiplication operations;
a first metal-oxide-metal capacitor (MOMCAP) for accumulating analog values; and
a stochastic-to-analog (S_to_A) circuit for converting stochastic data into analog charge for accumulation on the first MOMCAP;
wherein the PIM system is configured to:
perform multiplication operations on input vectors and weight matrices in the plurality of subarrays;
accumulate results of the multiplication operations on the first MOMCAP;
convert the analog accumulated values to binary values; and
generate final output of a multi-head attention layer.

11. The PIM system of claim 10, wherein the plurality of DRAM tiles includes a second MOSCAP that is disposed over the first MOMCAP.

12. The PIM system of claim 10, wherein each subarray of the plurality of subarrays includes a wordline (WL) driver.

13. The PIM system of claim 10, wherein each subarray of the plurality of subarrays is coupled to a near-subarray compute unit (NSC).

14. The PIM system of claim 13, wherein the NSC includes softmax logic, which includes a comparator and an adder/subtractor, and a binary-to-transition-coded-unary (B_to_TCU) decoder.

15. The PIM system of claim 10, wherein each subarray of the plurality of subarrays is coupled to a sense amplifier and latches component.

16. The PIM system of claim 10, wherein each the plurality of subarrays is coupled together and controlled by a bank controller.

17. The PIM system of claim 10, wherein the PIM system is further configured to perform at least the following:
distribute input matrices across a plurality of DRAM banks based on a token-sharding mechanism;
perform linear layer operations to generate query, key, and value matrices;
compute local attention scores in each of the plurality of DRAM banks, wherein the local attention scores are converted between stochastic and binary representations using S_to_B and B_to_S circuits, and transferred between DRAM banks using network switching circuits (NSCs);
perform attention score scaling and softmax operations using a log-sum-exp approach; compute attention output matrices; and
aggregate the results to generate the final output of the multi-head attention layer.

18. A processing-in-memory (PIM) system for accelerating transformer neural networks, comprising:
a plurality of subarrays, each subarray of the plurality of subarrays including a plurality of DRAM tiles, wherein each subarray of the plurality of subarrays comprises:
a plurality of bitlines for performing stochastic multiplication operations;
a metal-oxide-metal capacitor (MOMCAP) for accumulating analog values; and
a stochastic-to-analog (S_to_A) circuit for converting stochastic data into analog charge for accumulation on the MOMCAP;
wherein the PIM system is configured to:
perform a multiplication operation on an input vector and a weight matrix in the plurality of subarrays;
accumulate results of the multiplication operations on the MOMCAP;
convert the analog accumulated values to binary values; and
generate final output of a multi-head attention layer.

19. The PIM system of claim 18, wherein each subarray of the plurality of subarrays includes a wordline (WL) driver.

20. The PIM system of claim 18, wherein each subarray of the plurality of subarrays is coupled to a near-subarray compute unit (NSC), wherein the NSC includes softmax logic, which includes a comparator and an adder/subtractor, and a binary-to-transition-coded-unary (B_to_TCU) decoder.

21. The PIM system of claim 18, wherein each subarray of the plurality of subarrays is coupled to a sense amplifier and latches component.

22. The PIM system of claim 18, wherein each the plurality of subarrays is coupled together and controlled by a bank controller.
